(19) United States
(12) Patent Application Publication
(10) Pub. No.: US 2019/0068943 A1
(43) Pub. Date: Feb. 28, 2019

(54) Environment Perception System for Autonomous Vehicle

(71) Applicant: DENSO International America, Inc., Southfield, MI (US)

(72) Inventor: Trong Duy NGUYEN, Novi, MI (US)

(21) Appl. No.: 15/687,595

(22) Filed: Aug. 28, 2017

(51) Int. Cl. H04N 13/02; G06T 7/521; G06T 5/50

(52) U.S. Cl. CPC H04N 13/0242; H04N 13/0257; H04N 13/0271; H04N 13/0296; G06T 2207/10028; G06T 5/50; G06T 2207/20221; G06T 2207/10012; G06T 7/521

(57) ABSTRACT

An environment perception system for perceiving an environment about a vehicle having an autonomous drive system. The environment perception system includes a first camera that captures first images of the environment. A first camera controller generates first image data based on first images captured by the first camera. A second camera captures second images of the environment. A second camera controller generates second image data based on second images captured by the second camera. A ranging scanner measures distances between the vehicle and objects within the environment. A ranging controller generates ranging data based on the distances measured by the ranging scanner. A fusion controller generates three-dimensional data representative of the environment based on the first image data, the second image data, and the ranging data.

### FIELD

The present disclosure relates to an environment perception system for an autonomous vehicle.

### BACKGROUND

This section provides background information related to the present disclosure, which is not necessarily prior art.

An autonomous vehicle typically includes an environment perception system that gathers data regarding the surrounding environment, and inputs that data to an autonomous drive system, which drives the vehicle. Thus, it is imperative that the environment perception system accurately and quickly perceive the environment about the vehicle. While existing autonomous vehicle environment perception systems are suitable for their intended use, they are subject to improvement. The present teachings include an autonomous vehicle environment perception system that provides numerous advantages over existing systems, as explained herein and as one skilled in the art will recognize.

### SUMMARY

This section provides a general summary of the disclosure, and is not a comprehensive disclosure of its full scope or all of its features.

The present teachings provide for an environment perception system for perceiving an environment about a vehicle having an autonomous drive system. The environment perception system includes a first camera that captures first images of the environment. A first camera controller generates first image data based on first images captured by the first camera. A second camera captures second images of the environment. A second camera controller generates second image data based on second images captured by the second camera. A ranging scanner measures distances between the vehicle and objects within the environment. A ranging controller generates ranging data based on the distances measured by the ranging scanner. A fusion controller generates three-dimensional data representative of the environment based on the first image data, the second image data, and the ranging data.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of select embodiments and not all possible implementations, and are not intended to limit the scope of the present disclosure.

FIG. 1 illustrates an autonomous vehicle including an environment perception system in accordance with the present teachings;

FIG. 2 illustrates exemplary components of the environment perception system according to the present teachings;

FIG. 3A illustrates a subject vehicle including the environment perception system according to the present teachings gathering image data and ranging data of an object partially obscured by an obscurant;

FIG. 3B illustrates image data of the partially obscured object gathered by a first camera of the system according to the present teachings;

FIG. 3C illustrates image data of the partially obscured object gathered by a second camera of the system according to the present teachings; and

FIG. 3D illustrates three-dimensional data of the partially obscured object generated by the system of the present teachings based on image data gathered by the first camera, the second camera, and a ranging scanner.

Corresponding reference numerals indicate corresponding parts throughout the several views of the drawings.

### DETAILED DESCRIPTION

Example embodiments will now be described more fully with reference to the accompanying drawings.

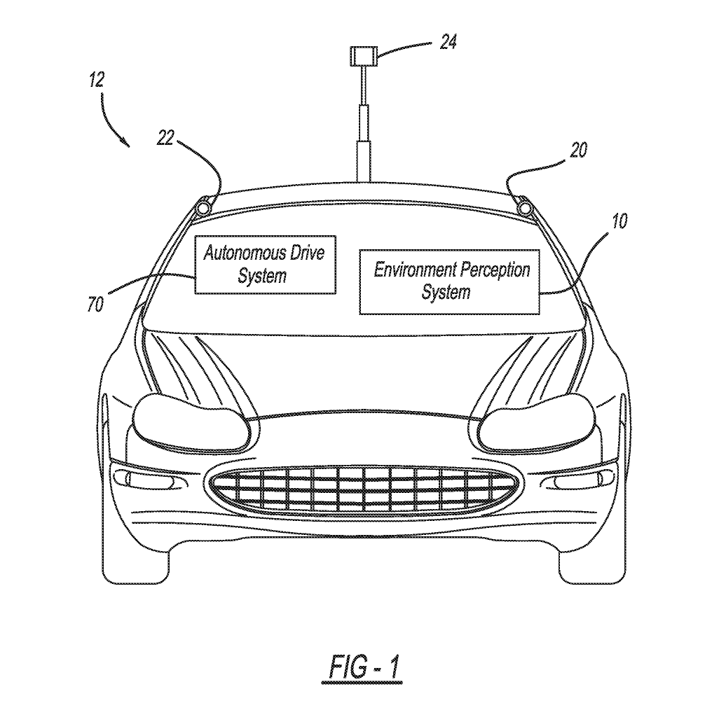

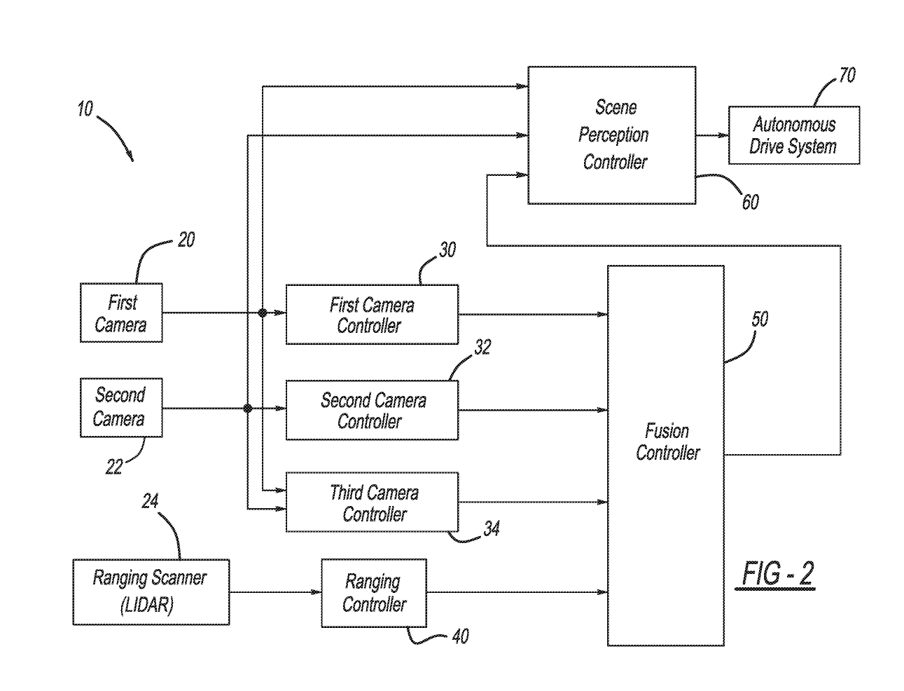

FIGS. 1 and 2 illustrate an environment perception system 10 for perceiving an environment around a vehicle 12. The vehicle 12 includes an autonomous drive system 70 for at least partially driving the vehicle 12. The vehicle 12 may be any suitable vehicle, such as any suitable passenger vehicle, mass transit vehicle, utility vehicle, military vehicle, watercraft, aircraft, etc.

The environment perception system 10 includes a first camera 20 and a second camera 22. The first camera 20 and the second camera 22 can be mounted at any suitable position about the vehicle 12. In the example of FIG. 1, the first camera 20 is mounted at a roof of the vehicle 12 on a driver's side of the vehicle 12. The second camera 22 is also mounted to the roof of the vehicle 12, but on the passenger's side. The first and second cameras 20 and 22 can be any suitable visual light cameras suitable for sensing a scene in an environment about the vehicle 12. For example, the first and second cameras 20 and 22 can be any cameras suitable to capture images of the scene, including images of, but not limited to, the following: other vehicles proximate to the subject vehicle 12; gaps between other vehicles through which the subject vehicle 12 can safely pass; pedestrians; traffic signs; traffic lights; landmarks; lane markers; animals; traffic conditions; weather conditions; etc.

The first and second cameras 20 and 22 can be multi-pose cameras controlled by two separate electric motor-based actuators. Steering angle of the vehicle 12, that which is available from controller area network (CAN) messages, can be used to supply information to the actuators to synchronize the positions of the first and second cameras 20 and 22 with the steering wheel of the vehicle 12. By synchronizing the angles of the first and second cameras 20 and 22 with the angle of the steering wheel of the vehicle 12, the first and second cameras 20 and 22 can closely track the steering wheel position to acquire a wide perspective of the environment.

The environment perception system 10 further includes a ranging scanner 24 that measures distances between the subject vehicle 12 and other objects within the scene in the environment about the subject vehicle 12. Any suitable ranging scanner can be used, such as a light detection and ranging (LIDAR) scanner. The ranging scanner 24 can be arranged at any suitable position about the subject vehicle 12, such as mounted to the roof thereof between the first camera 20 and the second camera 22 as illustrated in FIG. 1. The ranging scanner 24 advantageously measures distances between the subject vehicle 12 and other objects more accurately than the first and second cameras 20 and 22. Furthermore, the ranging scanner 24 can measure distances and provide depth perception data while the subject vehicle 12 is stationary, which is in contrast to the first and second cameras 20 and 22. The ranging scanner 24 can measure the distance between the subject vehicle 12 and any suitable object, such as, but not limited to, the following: other vehicles; pedestrians; buildings and other structures; trees; and any other obstacle. Although, the ranging scanner 24 does not specifically identify the object, image data from the first and second cameras 20 and 22 is used by the system 10 to identify the specific object, as explained further below.

The environment perception system 10 further includes a first camera controller 30 and a second camera controller 32. In this application, including the definitions below, the term “controller” may be replaced with the term “circuit.” The term “controller” may refer to, be part of, or include processor hardware (shared, dedicated, or group) that executes code, and memory hardware (shared, dedicated, or group) that stores code executed by the processor hardware. The code is configured to provide the features of the controllers described herein. The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc). The controllers described herein may also include a field-programmable gate array (FPGA).

The first camera controller 30 receives images (first images) captured by the first camera, and generates first image data based on the images captured on the first camera 20. Similarly, the second camera controller 32 receives images (second images) captured by the second camera 22 and generates second image data based on the images captured by the second camera 22. The first image data generated by the first camera controller 30 and the second image data generated by the second camera controller 32 can be in any form suitable for identifying and tracking objects in a scene of an environment about the subject vehicle 12. For example, the first image data and the second image data can be first point cloud data and second point cloud data respectively. The first and second point cloud data can include any suitable data of the images captured (and the objects captured in the images) such as, but not limited to, the following: X, Y, Z coordinate data; red, green, blue (RGB) color data; and/or intensity data (I) representing a depth of the image captured.

The system 10 further includes a third camera controller 34. The third camera controller 34 receives the first images captured by the first camera 20 and the second images captured by the second camera 22. Based on the first and second images combined, the third camera controller 34 generates third image data, such as third point cloud data. The third point cloud data can include any suitable data of the first and second images, such as, but not limited to, the following: X, Y, Z coordinate data; and/or intensity data (I) representing depth of the captured images.

The environment perception system 10 further includes a ranging controller 40. The ranging controller 40 generates ranging data based on the distances measured by the ranging scanner 24. The ranging controller 40 can be a standalone controller, or can be integrated with the ranging scanner 24. The ranging data can include ranging point cloud data of the scene being captured in the environment about the subject vehicle 12.

The environment perception system 10 further includes a fusion controller 50. Each one of the controllers 30, 32, 34, 40, and/or 50 can be any suitable controller, such as a field-programmable gate array (FPGA). The fusion controller 50 generates three-dimensional data representative of the environment about the subject vehicle 12, such as of a particular scene within the environment. The three-dimensional data is based on, for example, the first image data generated by the first camera controller 30 (such as first point cloud data), the second image data generated by the second camera controller 32 (such as second point cloud data), the third image data generated by the third camera controller 34 (such as the third point cloud data), and the ranging data generated by the ranging controller 40 (such as ranging point cloud data). The three-dimensional data generated by the fusion controller 50 includes one or more of the following: X, Y, Z coordinate data; red, green, blue color data; and intensity data representing image depth.

The three-dimensional data generated by the fusion controller 50 is input to a scene perception controller 60. The first images captured by the first camera 20 and the second images captured by the second camera 22 are also input directly to the scene perception controller 60. Based on these inputs, the scene perception controller 60 generates scene perception data. The scene perception data provides information of the environment about the subject vehicle 12, and specifically of particular scenes of the environment captured by the system 10, for use by the autonomous drive system 70 for vehicle path planning and decision making.

For example, the scene perception data can identify a gap in traffic that the subject vehicle 12 may pass through. Based on this scene perception data, the autonomous drive system 70 can safely and successfully drive the subject vehicle 12 through the gap in traffic. Similarly, the scene perception data can indicate to the autonomous drive system 70 that a lane adjacent to the subject vehicle 12 is clear for the vehicle 12 to use for passing. The autonomous drive system 70 can then steer the subject vehicle 12 to the passing lane in order to pass slower traffic (or avoid an obstacle). The scene perception data can also include data identifying traffic signs or traffic lights. If the scene perception data includes a stop sign or a red traffic light, for example, upon receipt of the data the autonomous drive system 70 will stop or otherwise operate the subject vehicle 12 so as to be in compliance with the stop sign or traffic signal (or any other type of traffic regulation).

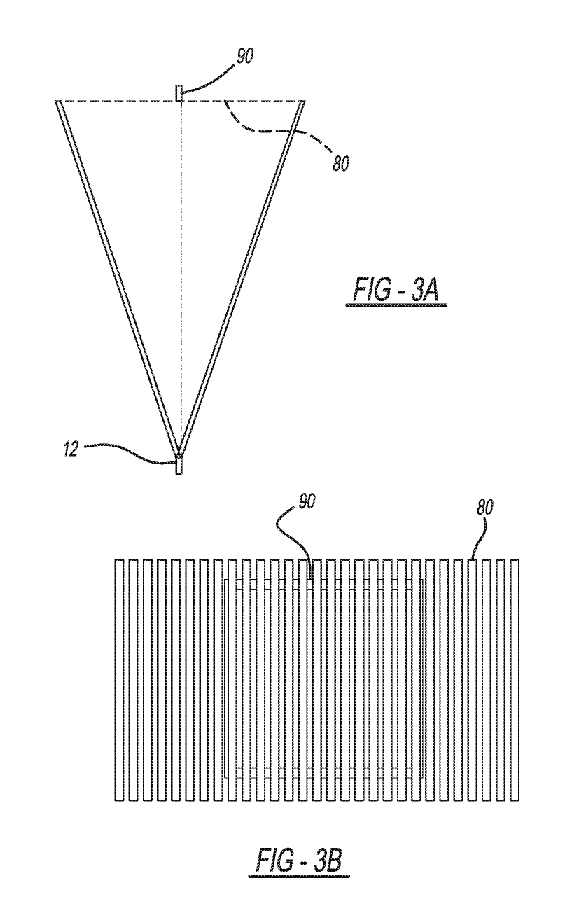

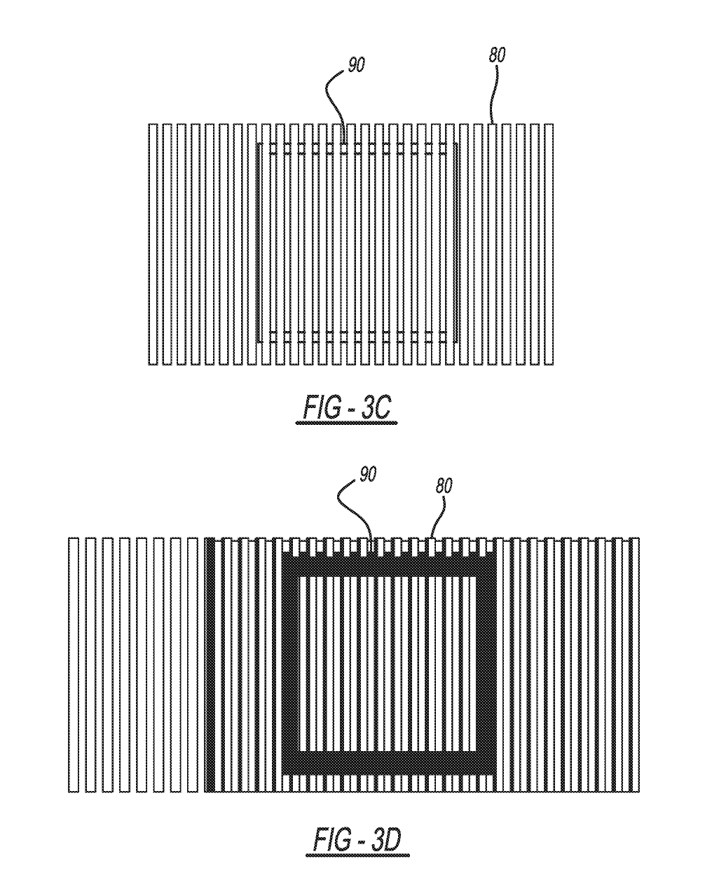

FIGS. 3A-3D illustrate fusion of data from the first camera 20, the second camera 22, and the ranging scanner 24 to obtain location information for an object 90 (such as a traffic sign, other vehicle, pedestrian, building, etc.) behind an obscurant 80. The obscurant 80 can be anything that may obscure the view of the object 90 by the first camera 20 and the second camera 22. For example, the obscurant 80 can be another vehicle directly in front of the subject vehicle 12, any other object directly in front of the subject vehicle 12, or severe weather, such as severe rain, snow, sleet, etc.

FIG. 3A illustrates the subject vehicle 12 on one side of the obscurant 80, and the object of interest 90 on an opposite side of the obscurant 80. FIG. 3B illustrates a first image captured by the first camera 20 of the object 90 through the obscurant 80. FIG. 3C illustrates a second image captured by the second camera 22 of the object 90 through the obscurant 80.

FIG. 3D illustrates three-dimensional data of the object 90 generated by the fusion controller 50 based on first images of the object 90 captured by the first camera 20, second images of the object 90 captured by the second camera 22, and ranging data from the ranging scanner 24. Therefore, and as illustrated in FIG. 3D, the system 10 advantageously provides full three-dimensional data of the object 90 even though the object 90 is partially obscured by the obscurant 80.

Positioning the first camera 20 and the second camera 22 on opposite sides of the vehicle 12, as illustrated in FIG. 1 for example, advantageously increases the amount of data that the environment perception system 10 can capture of the environment about the subject vehicle 12 (i.e., effectively increases the field of vision of the system 10). For example, if only a single camera was mounted at a center of the vehicle 12, or on one side of the vehicle 12, objects of interest in the environment could be obscured by other objects directly in front of the single camera. The multi-pose first and second cameras 20 and 22 advantageously provide an increased field of vision over what only a driver would see sitting on one side of the vehicle 12, and what a passenger would see sitting on an opposite side of the vehicle 12.

An additional advantage of the environment perception system 10 includes enhanced depth perception (generation of three-dimensional data) of particular scenes captured in the environment of the subject vehicle 12 due to the use of both first and second cameras 20 and 22, and the ranging scanner 24. By combining data from the first camera 20, the second camera 22, and the ranging scanner 24 using the fusion controller 50 and the scene perception controller 60, the system 10 according to the present teachings provides improved depth perception as compared to systems that employ only cameras or ranging scanners.

Additional advantages of the environment perception system 10 include use of the dedicated first camera controller 30 to process the first images captured by the first camera 20, and the dedicated second camera controller 32 to process the second images captured by the second camera 22. By using the separate first and second camera controllers 30 and 32, as well as the separate third camera controller 34 and ranging controller 40, the system 10 advantageously makes use of distributed computation (or processing) to prevent system overload.

Using both the first camera 20 and the second camera 22 also advantageously allows for use of data from one of the first and second cameras 20 and 22 to safely guide the vehicle 12 (such as to a road shoulder) in the event that one of the first camera 20 and the second camera 22 fails.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An environment perception system for perceiving an environment about a vehicle having an autonomous drive system, the environment perception system comprising:
a first camera that captures first images of the environment;
a first camera controller that generates first image data based on first images captured by the first camera;
a second camera that captures second images of the environment;
a second camera controller that generates second image data based on second images captured by the second camera;
a ranging scanner that measures distances between the vehicle and objects within the environment;
a ranging controller that generates ranging data based on the distances measured by the ranging scanner; and
a fusion controller that generates three-dimensional data representative of the environment based on the first image data, the second image data, and the ranging data.

2. The environment perception system of claim 1, wherein the first camera and the second camera are visible light cameras.

3. The environment perception system of claim 1, wherein the ranging scanner is a light detection and ranging (LIDAR) scanner.

4. The environment perception system of claim 1, wherein:
the first image data includes first point cloud data of the environment; and
the second image data includes second point cloud data of the environment.

5. The environment perception system of claim 4, wherein the first point cloud data and the second point cloud data include: X, Y, Z coordinate data; red, green, blue data; and intensity data.

6. The environment perception system of claim 5, wherein the first point cloud data and the second point cloud data each include data of a scene about the vehicle, the scene including at least one of the following: another vehicle, drivable gaps between other vehicles, a pedestrian, a traffic sign, a traffic light, lane markers, a landmark, and an animal.

7. The environment perception system of claim 1, wherein the ranging data includes ranging point cloud data of the environment about the vehicle

8. The environment perception system of claim 1, wherein the three-dimensional data generated by the fusion controller includes: X, Y, Z coordinate data; red, green, blue color data; and intensity data.

9. The environment perception system of claim 1, further comprising a scene perception controller that generates scene perception data based on the three-dimensional data generated by the fusion controller.

10. The environment perception system of claim 9, wherein the scene perception controller receives the first image data directly from the first camera, and receives the second image data directly from the second camera; and
wherein the scene perception controller generates scene perception data based on the first image data received directly from the first camera, and based on the second image data received directly from the second camera.

11. The environment perception system of claim 1, further comprising a third camera controller that generates third image data based on both first images captured by the first camera and second images captured by the second camera;
wherein the fusion controller generates three-dimensional data based on the first image data, the second image data, the third image data, and the ranging data.

12. An environment perception system for perceiving an environment about a vehicle having an autonomous drive system, the environment perception system comprising:
a first camera that captures first images of the environment;
a first camera controller that generates first point cloud data based on first images captured by the first camera;
a second camera that captures second images of the environment;
a second camera controller that generates second point cloud data based on second images captured by the second camera;
a third camera controller that generates third point cloud data based on both first images captured by the first camera and second images captured by the second camera;
a light detection and ranging (LIDAR) scanner that measures distances between the vehicle and objects within the environment;
a fusion controller that generates three-dimensional data representative of the environment based on the first point cloud data, the second point cloud data, the third point cloud data, and ranging point cloud data generated based on the distances measured by the LIDAR scanner; and
a scene perception controller that generates scene perception data based on the three-dimensional data generated by the fusion controller, and based on both the first images and the second images.

13. The environment perception system of claim 12, further comprising a ranging controller that generates the ranging point cloud data based on the distances measured by the LIDAR scanner.

14. The environment perception system of claim 12, wherein the first camera is mounted to a first side of the vehicle, the second camera is mounted to a second side of the camera, and the LIDAR scanner is mounted to the vehicle between the first camera and the second camera.

15. The environment perception system of claim 12, wherein the first camera and the second camera are visible light cameras.

16. The environment perception system of claim 12, wherein the first point cloud data and the second point cloud data include: X, Y, Z coordinate data; red, green, blue color data; and intensity data.

17. The environment perception system of claim 16, wherein the third point cloud data includes X, Y, Z coordinate data and intensity data.

18. The environment perception system of claim 17, wherein the first point cloud data, the second point cloud data, and the third point cloud data each include data of a scene about the vehicle, the scene including at least one of the following: another vehicle, drivable gaps between other vehicles, a pedestrian, a traffic sign, a traffic light, a landmark, and an animal.

19. The environment perception system of claim 12, wherein the three-dimensional data generated by the fusion controller includes: X, Y, Z coordinate data; red, green, blue color data; and intensity data.
